(19) United States
(12) Patent Application Publication
(10) Pub. No.: US 2008/0141907 A1
(43) Pub. Date: Jun. 19, 2008

(54) Screed Comprising Recycled Glass Waste

(75) Inventor: Sean J. Campbell, Surrey (GB)

Correspondence Address: HESLIN ROTHENBERG FARLEY & MESITI PC, 5 COLUMBIA CIRCLE, ALBANY, NY, 12203, US

(73) Assignee: Transmix Group Ltd., Oxshott (GB)

(21) Appl. No.: 10/556,642

(22) PCT Filed: Feb. 17, 2004
(86) PCT No.: PCT/GB04/00628

§ 371 Date: Nov. 15, 2006

(30) Foreign Application Priority Data
May 14, 2003 (GB) 03110715

(51) Int. Cl. C04B 28/14

(52) U.S. Cl. 106/695; 106/782; 106/716; 106/705; 524/2

(57) ABSTRACT

A screed for applying to eg a concrete slab, etc to give a smooth surface finish comprises recycled glass waste sand residue. In a preferred embodiment the screed comprises (i) recycled glass waste or a recycled glass waste sand residue in the form of an aggregate or powder; and (ii) a calcium sulphate powder binder. A method for production of a screed is described as well as a method for remediation of recycled glass waste.

The present invention relates to a flowing screed, for example an anhydrite or alpha-hemihydrate calcium sulphate based flowing floor screed, a cementitious flowing floor screed or a blended cementitious flowing floor screed comprising recycled waste glass sand for the construction of floating, unbonded and bonded screeds. In addition the invention relates to a method for the production of screeds and a method of the remediation of recycled glass waste via the production of any of the above flowing screed types in either bagged format or through delivery to site in bulk.

Within the context of this specification the word “comprises” is taken to mean “includes, among other things”. It is not Intended to be construed as “consists of only”.

A flowing screed is one which can be pumped or poured and comprises a mixture of cement/s, aggregate/sand and water, calcium sulphate aggregate/sand and water applied to a eg concrete slab, Insulation board or over underfloor heating etc to give a smooth surface finish. Known screeds of this type are ISOCRETE GYVLON™ supplied by Isocrete, LAFARGE GYVLON and AGILIA SCREED supplied by Lafarge, RMC READY-SCREED SUPAFLO supplied by RMC and TARMAC TRUFLOW supplied by Tarmac.

An ever increasing volume of glass waste is resulting in considerable pressure on available land fill space. In view of this, considerable pressure is being exerted to clean up environmental problems associated with the disposal of glass and one process that has been developed to reduce this pressure is a process involving the recycling of waste glass. In this recycling process the waste glass is generally subjected to crushing, washing, grading and sieving to provide a glass sand.

The process however suffers from the disadvantage that the residue glass sand must then be disposed of. At present this is achieved by incorporation into tarmac/ashphalt and roadfill sub-base materials. Clearly, other methods of disposal are desirable.

Therefore, a need exists for a process for the remediation of recycled glass waste to produce a product which is environmentally stable. In addition there is a need for a new product comprising recycled glass waste which is environmentally stable.

The present invention addresses or reduces at least one of the problems set out above.

It has now been found that screed production is one possible method of remediation and encapsulation of the waste glass material within an inorganic matrix resulting in an non-contaminating stable product. Advantageously, the process eliminates the need for landfill disposal of the waste glass and reduces the need for mined or quarried natural materials to be used.

Consequently, in a first aspect the present invention provides a screed comprising components including recycled glass waste or recycled glass waste sand residue.

Preferably an embodiment of the screed according to the invention is a flowing screed which preferably comprises recycled glass waste In the form of an aggregate or powder. A flowing screed comprises water In an amount that enables the screed to flow.

Preferably an embodiment of a screed according to the invention comprises a recycled glass waste or recycled glass waste sand residue. Preferably, an embodiment of the screed comprises 10% to 80% by weight of the recycled glass waste or recycled glass waste sand residue. More preferably, an embodiment of the screed comprises 20% to 70% by weight of the recycled glass waste or recycled glass waste sand residue. This provides the advantage that the glass being of a lower specific gravity than conventional sand floats more easily In the flowing floor screed suspension than conventional sands and or aggregates.

Preferably an embodiment of a screed according to the Invention additionally comprises a powder binder or slurry preferably comprising at least one of Calcium Sulphate, Portland Cement, High Alumina Cement, Calcium Sulpho-Aluminate Cement, Silica Fume, Limestone Powder, Pulverised Fuel Ash blast furnace slag or a combination of two or more thereof. More preferably the powder binder comprises Calcium Sulphate. Most preferably the powder binder comprises Calcium Sulphate combined with at least one of water, portland cement, High Alumina Cement, Calcium Sulpho-Aluminate Cement, Silica Fume, Limestone Powder, Pulverised Fuel Ash, blast furnace slag or a combination of two or more thereof. Preferably the Calcium Sulphate is combined with 10% to 90% by weight of at least one of water, portland cement, High Alumina Cement, Calcium Sulpho-Aluminate Cement, Silica Fume, Limestone Powder, Pulverised Fuel Ash, blast furnace slag or a combination of two or more thereof.

Preferably an embodiment of the screed comprises 5% to 90%, more preferably 5% to 80%, more preferably 10% to 80%, by weight of the powder binder or slurry preferably an embodiment of the screed comprises recycled glass waste combined with 30% to 80% by weight of the powder binder or slurry.

Preferably the calcium sulphate is selected from at least one of alpha hemihydrate, beta hemihydrate, anhydrite or a combination of two or more thereof.

Preferably an embodiment of the screed comprises a cement selected from at least one of Portland Cement, High Alumina Cement, Calcium Sulpho-Aluminate Cement or a combination of two or more thereof.

Preferably, an embodiment of a screed according to the present invention comprises a mixture of High Alumina Cement and Portland Cement. Preferably this embodiment of the screed comprises from about 10% to about 90%, more preferably from about 10% to about 80% high alumina cement and from about 1% to about 20% Portland cement. More preferably this embodiment of the screed comprises from about 20% to about 80% high alumina cement and from about 5% to about 15% Portland cement.

Preferably, an alternative embodiment of a screed according to the present invention comprises a mixture of Calcium Sulpho-Aluminate Cement and Portland Cement. Preferably this embodiment of the screed comprises from about 10% to about 90%, more preferably from about 10% to about 80% Calcium Sulpho-Aluminate and from about 1% to about 20% Portland cement. More preferably this embodiment of the screed comprises from about 20% to about 80% Calcium Sulpho-Aluminate and from about 5% to about 15% Portland cement.

Preferably, an embodiment of a screed according to the invention additionally comprises calcium sulphate. Preferably, this embodiment of the screed comprises from about 5% to about 50% alpha-hemihydrate plaster, beta-hemihydrate plaster and/or anhydrite. More preferably, this embodiment of the screed comprises about 40% alpha-hemihydrate plaster and/or anhydrite.

Preferably an embodiment of a screed according to the present invention comprises a limestone powder filler. More preferably, this embodiment of the screed comprises about 10% to about 40%, more preferably from about 10% to about 35% limestone powder filler.

Preferably an alternative embodiment of a screed according to the present invention comprises a pulverised fuel ash powder filler. More preferably, this embodiment of the screed comprises about 10% to about 40%, more preferably from about 10% to about 35% pulverised fuel ash powder filler.

Preferably an alternative embodiment of a screed according to the present invention comprises a silica fume powder filler. More preferably, this embodiment of the screed comprises about 5% to about 20% silica fume powder filler.

Preferably, an embodiment of a screed according to the invention comprises a retarder to retard the cement hydration or calcium sulphate set time thereby extending the pot-life of the flowing screed. Preferably the retarder comprises at least one of citric acid, tartaric acid, boric acid, sodium gluconate, Rochelle salt, tri-sodium citrate, sodium tri-polyphosphate, a chelating agent or a combination of two or more thereof. Preferably, an embodiment of the screed comprises 0.025% to 2.0% by weight of the retarder. More preferably, an embodiment of the screed comprises 0.05% to 1% by weight of the retarder. More preferably, an embodiment of the screed comprises 0.2% to 0.8% by weight of the retarder.

Preferably, an embodiment of a screed according to the present invention comprises an accelerator to promote hydration of the cement or calcium sulphate materials or for promoting powder binder crystalline formation. Preferably the accelerator comprises at least one of lithium carbonate, sodium carbonate, an alkali earth salt, aluminium sulphate, potassium sulphate, a phosphate salt or a combination of two or more thereof. Preferably, an embodiment of the screed comprises 0.025% to 2.0% by weight of the accelerator. More preferably, an embodiment of the screed comprises 0.025% to 1% by weight of the accelerator. More preferably, an embodiment of the screed comprises 0.2% to 0.8% by weight of the accelerator. This provides the advantage that the cements and/or calcium sulphates will hydrate or set rapidly once retardation has ceased.

Preferably, an embodiment of a screed according to the present invention comprises a plasticiser. Preferably the plasticiser comprises at least one of a melamine, ligno-sulphonate, casein or a combination of two or more thereof which enhance the flow characteristics of the flowing floor screed without having to add excess water. Thus, reduced amounts of water can be used and/or excess water can be avoided. Preferably an embodiment of the screed comprises 0.02% to 2.00% by weight of the plasticiser. More preferably, an embodiment of the screed comprises 0.1% to 0.8% by weight of the plasticiser. More preferably, an embodiment of the screed comprises 0.2% to 0.5% by weight of the plasticiser.

Preferably, an embodiment of a screed according to the present invention comprises a liquid and/or powdered organic polymers. Preferably the liquid and/or powdered polymers comprise at least one of organic polymers, co-polymers, ter-polymers or a combination of two or more thereof which improve surface abrasion, bond strength to substrates and aggregate and or sand suspension. Preferably, an embodiment of the screed comprises 1% to 6% by weight of the liquid and/or powdered organic polymer. More preferably, an embodiment of the screed comprises 2% to 4% by weight of the liquid and/or powdered organic polymer. More preferably, an embodiment of the screed comprises 3% by weight of the liquid and/or powdered organic polymer.

In order to assist with understanding the number of components and their amounts In an embodiment of a screed according to the invention, Table 1 below shows the preferred components in tabular form wherein the components in the columns to the left are made up of the components in the column to the right. The % ranges show preferred amounts present by weight.

TABLE 1

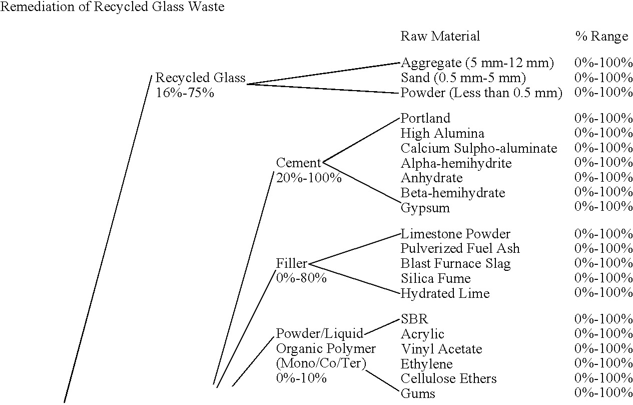

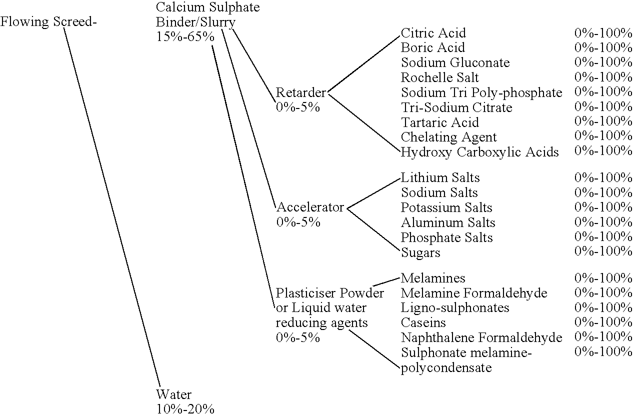

Where several components are specified as present in an amount of 0%-100% by weight, this indicates that that component could be optionally absent or present in an amount of up to 100% by weight. Clearly, a skilled person would appreciate that at least one of the optional components must be present.

In a second aspect the Invention provides a method for production of a screed according to a first aspect of the invention which comprises the steps of mixing the components in the required amounts.

Preferably, an embodiment of the method includes the steps of keeping the powder binder or slurry components separate from the glass sand until the screed is required and then mixing the components on site directly before applying the flowing screed to a floor substrate or of first combining the components and mixing them either on site or off site in a bulk ready-mix truck or ready-mix pump truck before applying the flowing screed to a floor substrate surface.

In a third aspect the Invention provides a method for remediation of recycled glass waste which comprises the steps of crushing, washing, sieving and grading of waste glass to produce a sand residue as a component In the production of a flowing screed.

Additional features and advantages of the present invention are described in, and will be apparent from, the description of the presently preferred embodiments which are set out below.

For the purposes of clarity and a concise description features are described herein as part of the same or separate embodiments, however it will be appreciated that the scope of the invention may include embodiments having combinations of all or some of the features described.

### EXAMPLE 1

In a preferred embodiment a flowing screed according to the invention comprises 10% to 80% by weight of recycled glass waste sand residue, 20% to 90% by weight alpha hemihydrate plaster, 0.025% to 2% by weight by weight retarder and 0.02% to 2.00% by weight of plasticiser.

### EXAMPLE 2

In an alternative preferred embodiment a screed according to the invention comprises 10% to 80% by weight of recycled glass waste sand, 20% to 90% by weight anhydrite and 0.025% to 2.00% by weight accelerator and 0.02% to 2.00% by weight of plasticiser.

### EXAMPLE 3

In an alternative preferred embodiment a screed according to the invention comprises 10% to 80% by weight of recycled glass waste sand, 20% to 90% by weight Portland cement.

### EXAMPLE 4

In an alternative preferred embodiment a screed according to the invention comprises 10% to 80% by weight of recycled glass waste sand, 10% to 80% by weight high alumina cement, 10% to 35% by weight limestone powder filler, 1% to 20% by weight Portland cement, 5% to 15% by weight beta-hemihydrate plaster and/or 5% to 15% by weight anhydrite, 0.025% to 2% by weight accelerator, 0.025% to 2% by weight retarder, and 0.020% to 2% by weight plasticiser.

### EXAMPLE 5

In an alternative preferred embodiment a screed according to the invention comprises 10% to 80% by weight of recycled glass waste sand, 10% to 80% by weight high alumina cement, 10% to 35% by weight limestone powder filler, 1% to 20% by weight Portland cement, 5% to 15% by weight beta-hemihydrate plaster and/or 5% to 15% by weight anhydrite, 0.025% to 2% by weight accelerator, 0.025% to 2% by weight retarder, 0.020% to 2% by weight plasticiser, and 1% to 5% by weight liquid and/or powdered organic polymer.

### EXAMPLE 6

In an alternative preferred embodiment a screed according to the Invention comprises 10% to 80% by weight of recycled glass waste sand, 10% to 80% by weight calcium sulph-aluminate cement, 10% to 35% by weight limestone powder filler, 1% to 20% by weight Portland cement, 5% to 15% by weight beta-hemihydrate plaster and/or 5% to 15% by weight anhydrite, 0.025% to 2% by weight accelerator, 0.025% to 2% by weight retarder, 0.020% to 1% by weight plasticiser, and 1% to 5% by weight liquid and/or powdered organic polymer

### EXAMPLE 7

In an alternative preferred embodiment a screed according to the Invention comprises 10% to 80% by weight of recycled glass waste sand, 10% to 80% by weight high alumina cement, 10% to 35% by weight limestone powder filler, 1% to 20% by weight Portland cement, 5% to 15% by weight beta-hemihydrate plaster and/or 5% to 15% by weight anhydrite, 5% to 20% silica fume, 0.025% to 2% by weight accelerator, 0.025% to 2% by weight retarder, 0.020% to 2% by weight plasticiser, and 1% to 5% by weight liquid and/or powdered organic polymer.

### EXAMPLE 8

In an alternative preferred embodiment a screed according to the invention comprises 10% to 80% by weight of recycled glass waste sand, 10% to 80% by weight calcium sulph-aluminate cement, 10% to 35% by weight limestone powder filler, 1% to 20% by weight Portland cement, 5% to 15% by weight beta-hemlhydrate plaster and/or 5% to 15% by weight anhydrite, 5% to 20% silica fume, 0.025% to 2% by weight accelerator, 0.025% to 2% by weight retarder, 0.020% to 1% by weight plasticiser, and 1% to 5% by weight liquid and/or powdered organic polymer

It should be understood that various changes and modifications to the presently preferred embodiments described herein will be apparent to those skilled in the art.

Such changes and modifications can be made without departing from the spirit and scope of the present invention and without diminishing its attendant advantages. It is therefore intended that such changes and modifications are covered by the appended claims.

1. A screed capable of flowing comprising (i) recycled glass waste or a recycled glass waste sand residue in the form of an agregate or powder; and (ii) a calcium sulphate powder binder.

2. A screed according to claim 1 which comprises 10% to 80% by weight of the recycled glass waste or a recycled glass waste sand residue.

3. A screed according to claim 1 or 2 which comprises 5% to 80% calcium sulphate powder binder.

4. A screed according to any preceding claim wherein the calcium sulphate is selected from at least one of alpha hemihydrate plaster, beta hemihydrate plaster, anhydrite or a combination of two or more thereof.

5. A screed according to any preceding claim wherein the calcium sulphate is combined with 10% to 90% by weight of at least one of water, Portland Cement, High Alumina Cement, Calcium Sulpho-Aluminate Cement, limestone powder, silica fume, pulverised fuel ash, blast furnace slag or a combination of two or more thereof.

6. A screed according to claim 5 which comprises a mixture of Calcium Sulphate, high alumina cement, and Portland cement.

7. A screed according to claim 6 which comprises 10% to 80% high alumina cement and from 1% to 20% Portland cement.

8. A screed according to claim 5 which comprises a mixture of Calcium Sulphate, calcium sulpho-aluminate cement, and Portland cement.

9. A screed according to claim 8 which comprises 10% to 80% calcium sulpho-aluminate cement and from 1% to 20% Portland cement.

10. A screed according to any preceding claim which comprises about 10% to about 35% limestone powder filler.

11. A screed according to any preceding claim which comprises about 10% to about 35% of a pulverised fuel ash powder filler.

12. A screed according to any preceding claim which comprises about 5% to about 20% silica fume powder filler.

13. A screed according to any preceding claim which comprises a retarder for retarding the powder binder crystalline formation thereby extending the pot-life of the flowing screed.

14. A screed according to claim 13 wherein the retarder comprises at least one of citric acid, tartaric acid, boric acid, sodium gluconate, Rochelle salt, tri-sodium citrate, sodium tri-polyphosphate a chelating agent or a combination of two or more thereof.

15. A screed according to claim 13 or 14 wherein the screed comprises 0.025% to 2.0% by weight of the retarder.

16. A screed according to any preceding claim which comprises an accelerator for promoting powder binder crystalline formation.

17. A screed according to claim 16 wherein the accelerator comprises at least one of lithium carbonate, sodium carbonate, an alkali earth salt, aluminium sulphate, potassium sulphate, a phosphate salt or a combination of two or more thereof.

18. A screed according to claim 17 wherein the screed comprises 0.025% to 2.0% by weight of the accelerator.

19. A screed according to any preceding claim which comprises a plasticiser.

20. A screed according to claim 19 wherein the plasticiser comprises at least one of a melamine, ligno-sulphonate, casein or a combination of two or more thereof which enhance the flow characteristics of the flowing floor screed without having to add excess water.

21. A screed according to claim 19 or 20 wherein the screed comprises 0.02% to 2.00% by weight of the plasticiser.

22. A screed according to any preceding claim which comprises a liquid and/or powdered organic polymer.

23. A screed according to claim 22 wherein the liquid and/or powdered polymers comprise at least one of organic polymers, co-polymers, ter-polymers or a combination of two or more thereof which improve surface abrasion, bond strength to substrates, aggregate or sand suspension.

24. A screed according to claim 22 or 23 wherein the screed comprises 1% to 6% by weight of the liquid and/or powdered organic polymer.

25. A method for production of a screed according to any one of claims 1 to 24 which comprises the steps of mixing the components in the required amounts.

26. A method according to claim 25 which includes the steps of keeping the components separate until the screed is required and then mixing the components on site directly before applying the flowing screed to a floor substrate or of first combining the components and mixing them either on site or off site in a bulk ready-mix truck before applying the flowing screed to a floor substrate surface.

27. A method for remediation of recycled glass waste which comprises at least one of the steps of crushing, washing, sieving and grading of waste glass to produce a sand residue as a component in the production of a flowing screed.

28. A screed as described herein with reference to the accompanying examples.
